(19) United States
(12) Patent Application Publication
(10) Pub. No.: US 2007/0085739 A1
(43) Pub. Date: Apr. 19, 2007

(54) Mobile information and entertainment appliance

(76) Inventor: Jim Udall, Surrey (CA)

Correspondence Address: Robert E. Krebs;THELEN REID & PRIEST LLP, P. O. Box 640640, San Jose, CA, 95164-0640, US

(21) Appl. No.: 11/252,683

(22) Filed: Oct. 17, 2005

(51) Int. Cl. G01S 5/14

(52) U.S. Cl. 342/357.17

(57) ABSTRACT

An information appliance is provided, comprising means for reading a pre-recorded media; a keyboard; a screen; means for WLAN connectivity; a GPS receiver; and speakers and a amplifier. The appliance may be used to experience media, by selecting a radio frequency; accessing a record to determine an association with said radio frequency and a web page; and displaying said associated web page on said information appliance. The appliance may also be used to select a radio frequency, with a the GPS receiver, by determining, using the GPS receiver, the location of said listener; accessing a database to determine a plurality of radio stations available at said location; and presenting, for selection by said listener, on said information appliance, at least one of said available radio stations. The appliance can also be used to locate a WLAN access point, by determining, using a GPS receiver, the location of said listener; accessing a database to determine a plurality of WLAN access points available at said location; and presenting, for selection by said user, at least one of said WLAN access points.

This application claims the benefit of U.S. Provisional Patent Application No. 60/618,141 filed Oct. 14, 2004.

### BACKGROUND OF THE INVENTION

1. Field of the Invention

This invention relates generally to mobile information and entertainment appliances and more particularly to appliances with GPS, wireless Internet connectivity and radio tuning capability.

2. Background

There are a wide variety of information and entertainment appliances available in the marketplace. Many of these are highly specialized devices to obtain information from a specific type of input, and produce a specific type of output. An example of this would be a portable CD player. Such an appliance reads information from a CD, and converts it to sound. Portable CD players may include a radio receiver as well. The purpose of these appliances is, of course, to listen to music or other audio.

Another popular information appliance is the portable digital assistant (PDA). A PDA features a small touch screen typically operated with a touching device and may also have wireless capability. However, given their small size, they are not able play media such as CDs or DVDS, nor do they have full keyboards to allow rapid typing. The main purpose of a PDA is to record information and transmit that to another appliance (for example another PDA or a PC), and to access certain Internet sites.

Cellular phones are a rapidly developing information appliance originally designed to provide voice communications, and now including such features as wireless Internet browsing, a limited ability to play music and GPS capability. However, the size of a cellular phone limits the convenience with which it can be used, for example, it is very difficult to provide quick and easy keyboard functionality, and it cannot play content from CDs or DVDs. The primary function of a cellular phone is to speak to others via the phone, although other forms of communication such as MMS are also available.

Another entertainment appliance is the portable gaming device, such as the Gameboy™ made by Nintendo™ Corp. These tend to run software on cartridges or discs, but lack keyboards or GPS capability. Some gaming devices offer WLAN capability.

Laptop computers, while not information appliances (as they are not handheld) provide many more options. They typically have a fully functional keyboard, a screen, a CD player, and may be equipped with GPS and wireless communications. However, they are relatively expensive, often having more computing power than is needed and they tend to be bulky, when compared to an information appliance such as a Sony Discman™.

Some related art includes an Apparatus, Systems and Methods for Providing On-Demand Radio disclosed in PCT Application No. PCT/US00/02244 to Kwoh et al. and Location Dependent Services disclosed in EP 0813302 to Kaku.

### BRIEF SUMMARY OF THE INVENTION

This invention is for a portable, handheld device that enables the mobile consumption of a rich variety of information and entertainment. Through the coupling of various technologies, this device permits information and entertainment to be accessed wirelessly from the Internet, as well as through CD based distribution. By further adding FM radio reception and FM radio transmission the device can be used for accessing information and entertainment as well as sharing such information and entertainment. Through the addition of location determination technology, such as GPS, a new dimension of functionality is provided to that information and entertainment. Also, by the inclusion of a high-resolution colour screen and a full QWERTY keyboard with pointer, the complete desktop browsing experience is reproduced in a mobile form.

The device has a number of aspects, including a simple appliance model of service delivery. The suite of services the invention provides cannot generally be extended by the installation of user-installed software applications. Rather than being generally programmable, the device provides a very simple web browser interface to all its built-in services. The result is a very simplistic user interface with ubiquitous appeal.

An information appliance is provided, comprising means for reading a pre-recorded media; a keyboard; a screen; means for WLAN connectivity; a GPS receiver; and speakers and a amplifier. The appliance may be used to experience media, by selecting a radio frequency; accessing a record to determine an association with said radio frequency and a web page; and displaying said associated web page on said information appliance. The appliance may also be used to select a radio frequency, with a the GPS receiver, by determining, using the GPS receiver, the location of said listener; accessing a database to determine a plurality of radio stations available at said location; and presenting, for selection by said listener, on said information appliance, at least one of said available radio stations. The appliance can also be used to locate a WLAN access point, by determining, using a GPS receiver, the location of said listener; accessing a database to determine a plurality of WLAN access points available at said location; and presenting, for selection by said user, at least one of said WLAN access points.

### BRIEF DESCRIPTION OF THE DRAWINGS

FIG. 1 is a top view of an appliance embodying of the invention;

FIG. 2 is a side view thereof;

FIG. 3 is a perspective view thereof;

FIG. 4 is a perspective view thereof, showing the appliance opened to receive a disc;

FIG. 5 is a perspective view thereof, showing the appliance opened to use the keyboard and screen;

FIG. 6 is a perspective view thereof, showing the appliance held by a user;

FIG. 7 is an illustrative view of an alternative embodiment of the information appliance and its networking environment;

FIG. 8 is a perspective view of the information appliance thereof;

FIG. 9 is a block diagram of an embodiment of an information appliance according to the invention;

FIG. 10 is a block diagram of the GPS system chipset therein;

FIG. 11 is a block diagram of the audio subsystem thereof;

FIG. 12 is a block diagram of the WiFi subsystem thereof;

FIG. 13 is a view of an embodiment of the main screen thereof;

FIG. 14 is a view of a screen showing the WiFi tab therein;

FIG. 15 is a view of a screen showing the CD browsing tab therein;

FIG. 16 is a view of a screen showing the file management system thereof;

FIG. 17 is a view of the GPS management screen thereof;

FIG. 18 is a view of a screen showing the messaging tab therein;

FIG. 19 is a view of a screen showing the radio tuning tab therein; and

FIG. 20 is a view of a screen showing the radio broadcasting tab therein.

### DETAILED DESCRIPTION OF THE INVENTION

Definitions

In this document (including the claims), the following terms have the following meanings:

“information appliance” means a handheld tool capable of receiving digital information from an input means and converting such information into sound or images;

“experiencing media” means viewing a screen showing media and/or listening to media;

“web page” means a page of a document on the World Wide Web having an address known as a uniform resource locator (“URL”);

“WLAN” or “WiFi” means wireless local area network;

“access point” means a station that transmits and receives data (sometimes referred to as a transceiver) to a WLAN;

“USB” means Universal Serial Bus;

“PDF” means Postscript Display Format;

“MIME” means Multipurpose Internet Mail Extensions;

“PFS” means Portable File System;

“URI” means Uniform Resource Identifier; and

“peripheral” means a device connected to an information appliance to provide auxiliary functions.

Description

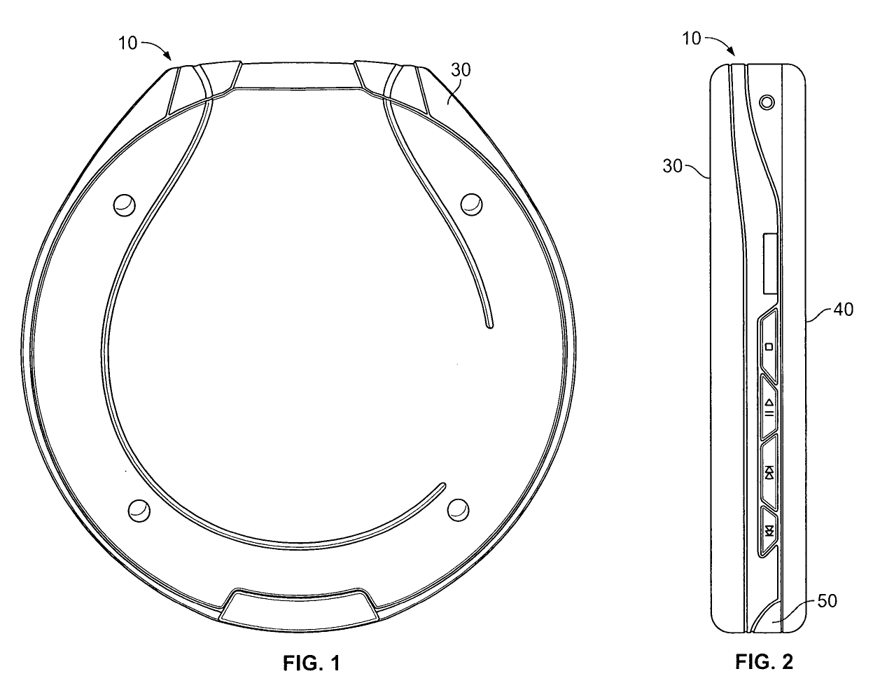

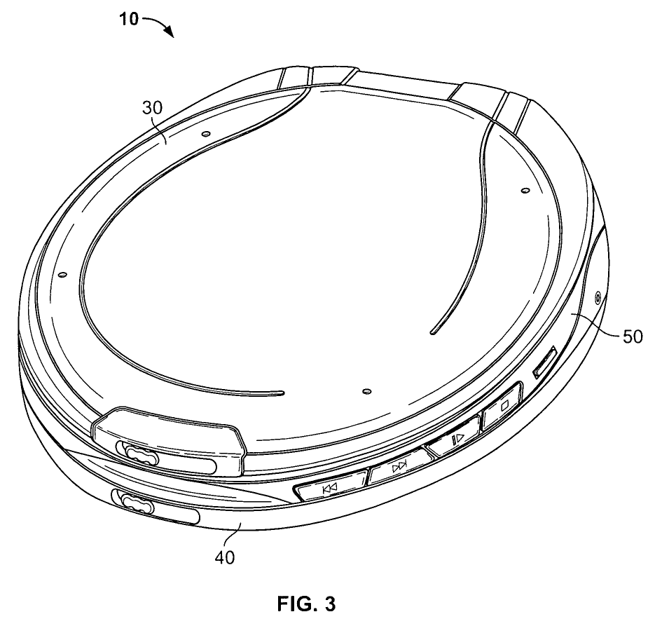

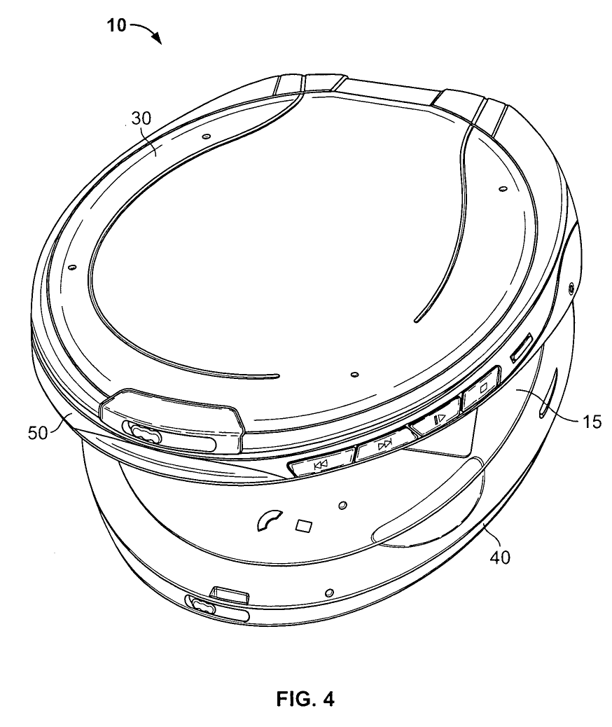

The information appliance 10, as seen in FIGS. 1 through 6, in one embodiment, is about the size of a portable CD player, but has additional technology, software and functionality for experiencing media. Information appliance 10 is designed to use principles of media experience that are familiar with users to minimize necessary education, making appliance 10 very easy to use, although appliance 10 should be adaptable in handling changes in technology (for instance by playing now ubiquitous DVDs as well as CDs).

Technologies

In a preferred embodiment, appliance 10 is a portable handheld device offering the following technologies:

1. CD drive 15 allowing the user to listen to CDs. Alternatively, another prerecordable media peripheral could be substituted or provided in addition, such as a flash memory slot, or a DVD drive;

2. Screen 20 to allow the user to view media and select options. In a preferred embodiment a LCD screen is used, with 800×600 resolution and 16 bit colour. In the closed “clamshell” position of the invention, screen 20 would be closed face down and thus protected. However, an embodiment of screen 20 may include swivel capability to permit closure of appliance 10 with screen 20 facing upwards. Such an embodiment would be convenient for the use of the appliance in situations where an open device may be awkward or unwieldy;

3. Keyboard 25 to allow the user to select options and input information. Preferably a full QWERTY keyboard is available with a joystick pointer;

4. A WLAN interface to allow users to communicate with the Internet. Preferably a 802.11b wireless interface is used;

5. A MMC flash memory slot for storing user content;

6. A USB port for connecting the appliance to a PC or other peripherals;

7. A GPS receiver and module to allow the user to determine the location of the appliance;

8. A radio receiver, preferably a FM radio receiver;

9. A radio transmitter, preferably a FM radio transmitter;

10. A built-in speaker with stereo headset connectivity to allow users to listen to media; and

11. A battery to provide power to the appliance. Preferably the battery is rechargeable so that the user does not have to switch batteries frequently.

In a preferred embodiment information appliance 10 will be sold with a wired stereo headset with a 3.5 mm jack, an AC power adaptor and a 12V cigarette lighter power adaptor. These technologies preferably allow information appliance 10 to playback a variety of CD formats including: standard audio CDs, MP3 encoded CDs, Video CDs, Kodak picture CDs, and general data CDs to allow an Internet browsing experience similar to that of a PC with the use of a screen 20, keyboard 25 and pointer. The GPS system allows the information appliance 10 to use location based services such as navigation, and appliance 10 is capable of simultaneous and synchronized FM radio listening with Internet browsing.

Information appliance 10 will also be able to provide instant message capabilities with software such as MSN Messenger™ and/or AOL™ messaging. Users may use the information appliance 10 for music sharing and downloading through both premium pay services and free sharing services and for Internet streaming and storing of audiovisual content from Internet-based servers. The appliance 10 may be used for audio sharing through the use of built-in speaker or via the external FM radio receiver and FM low power transmitter.

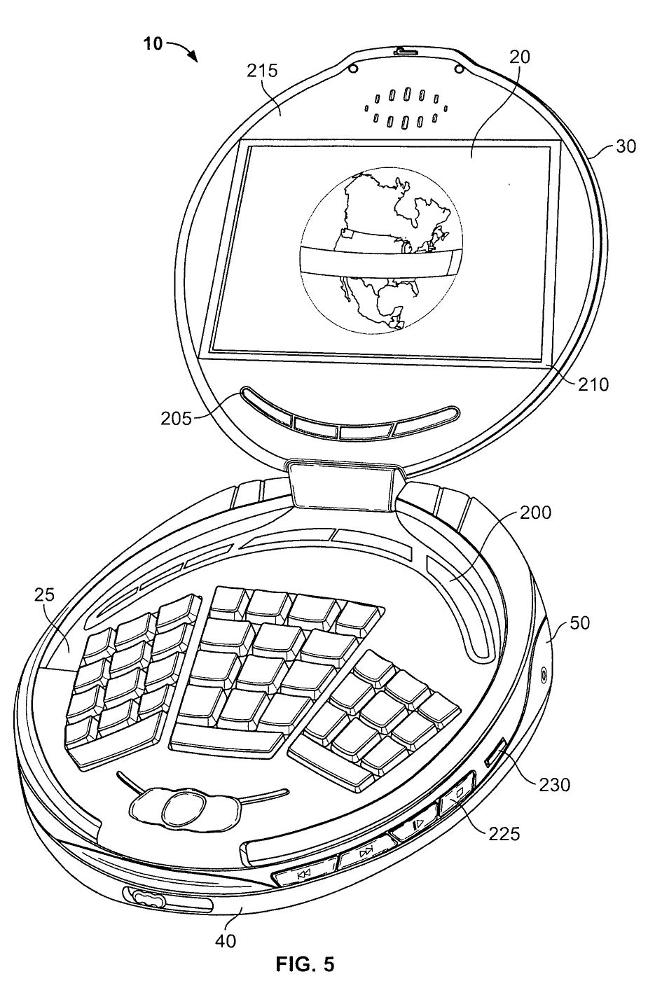

Information appliance 10 opens at two points. At the first point, the cover 30 can be raised, as seen in FIG. 5. On the inside of cover 30 is screen 20. Keyboard 25 on surface 50 is accessible after cover 30 is raised.

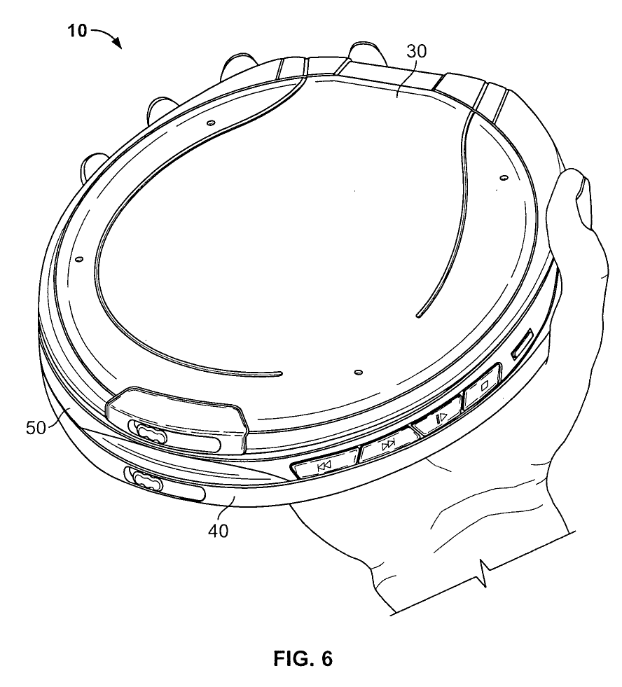

As seen in FIG. 4, bottom 40 can be lowered to allow insertion and removal of CDs. Cover 30 and bottom 40 snap shut with surface 50 using conventional means. FIG. 6 provides a sense of scale for information appliance 10 which can easily be held in one hand.

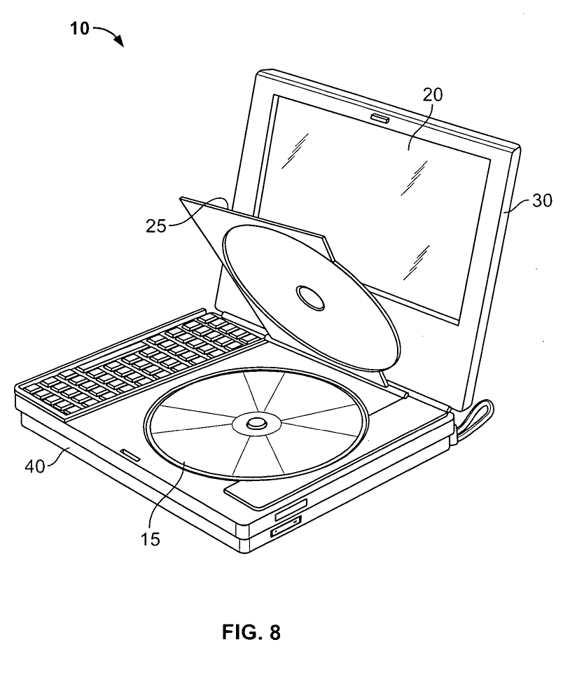

FIG. 8 shows an alternative embodiment of information appliance 10 wherein CDs are inserted or removed by lifting keyboard 25. Surface 50 is not required in this embodiment.

Environment

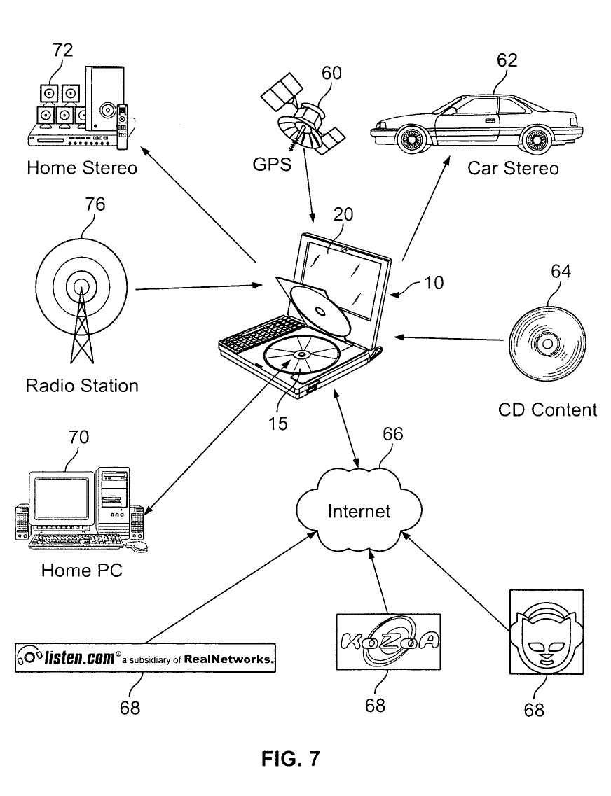

As seen in FIG. 7, the environment of information appliance 10 allows for access to and use of a variety of media sources. Information appliance 10 receives information from satellite 60 through its GPS subsystem. Information appliance 10 may output music from CDs and the like using conventional technology to car stereos 62 or external speakers, for example in a home stereo 72. Information appliance 10 can play CDs 64. Information appliance 10 can access the Internet 66 via the WLAN interface, and among other activities can download and upload music from appropriate music sharing websites 68.

Information appliance 10 can also access a PC 70 to upload or download information. Information appliance 10 can also receive radio signals from radio stations 76.

Hardware Architecture

The following description relates to a particular embodiment of the hardware architecture of an information appliance according to the invention. A person skilled in the art will be aware of many other architectures that can be used to embody the invention.

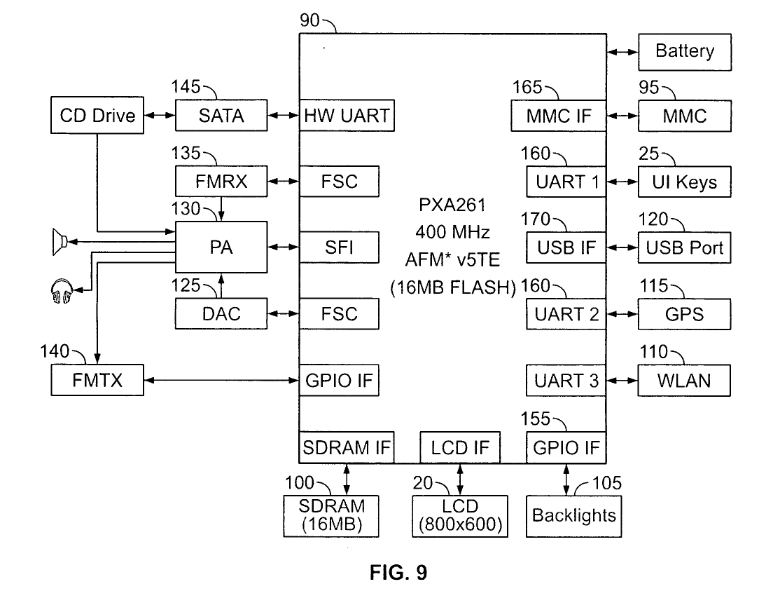

In the particular embodiment, as illustrated in FIG. 9, CPU 90 in information appliance 10 uses the Xscale™ architecture (in particular the PXA2621 processor) provided by Intel Corporation™. This processor contains the ARM™ version 5TE running at a clock rate of 400 Mhz. In addition to the ARM™ CPU, the PXA2621 processor offers a number of peripheral interface capabilities. Of course other architectures and CPUs are available in the art.

The PXA2621 processor is a layered package that in addition to the CPU module also includes 16 MB of NOR flash memory. This flash memory stores the operating system boot software and file system. The software manages the flash memory as a file system and allows the storing of downloaded code extensions. User content is preferably not stored in the flash memory but on the external MMC flash memory 95.

Preferably in addition to the Xscale™ core, information appliance 10 has additional memory 100, such as 16 MB of 32 bit wide SDRAM. This memory 100 is used for program execution and its state need not be preserved when the information appliance is not powered. Preferably the appliance has 32 bit wide memory to provide reasonable access to the large LCD buffer required for the 800×600 16 bit colour configuration.

As seen in FIG. 9, the CPU 90 contains the interfaces required to access the peripheral devices of information appliance 10.

Preferably CPU 90 communicates with the following peripherals: memory 100 (preferably 16 MB SDRAM with 32 bit width; screen 20 (preferably an LCD with 800×600 bit resolution and 16 bit colours); LED backlights 105 for screen 20; WLAN interface 110 with the 802.11g standard; GPS system 115 for GPS based location determination; USB port 120 (preferably meeting the external USB 2.0 interface standard); QWERTY keypad 25 and pointer; digital to analogue codec (DAC) component 125; audio power amplifier (PA) 130; FM radio receiver (FMRX) 135; FM radio transmitter (FMTX) 140; and Serial ATA (SATA) interface 145 to CD drive 150.

As information appliance 10 is portable, power management is important. CPU 90 should have a low power mode and each peripheral is preferably capable of its own power control. Software is used to manage the power management features of information appliance 10 and its peripherals.

Screen Architecture

Screen 20 is preferably an active matrix LCD unit with multiple frame buffers controlled using the LCD interface of CPU 90. The LCD includes backlight LEDs 105 controlled by the GPIO interface 155 capabilities of CPU 90.

Keyboard and Pointer

Both keypad 25 (and joystick) employ one of the four built in UARTS 160 of CPU 90. In alternative embodiments of the invention, different pointer controllers can be used instead of a joystick, such as touch pads or touch screens.

MMC Interface

CPU 90 preferably has a direct MMC flash memory interface 165 to MMC flash memory 95. User content is stored on this external user-swappable flash memory module. Preferably the MMC flash memory system 95 supports hot swap capability.

USB Interface

The external USB interface 170 connects directly to CPU 90. Preferably CPU 90 supports USB standard 2.0.

CD Interface

CD drive 156 is connected to CPU 90 via an external SATA interface chip 145. This provides a benefit over a serial ATA interface because of reduced complexity and smaller physical footprint.

GPS Subsystem

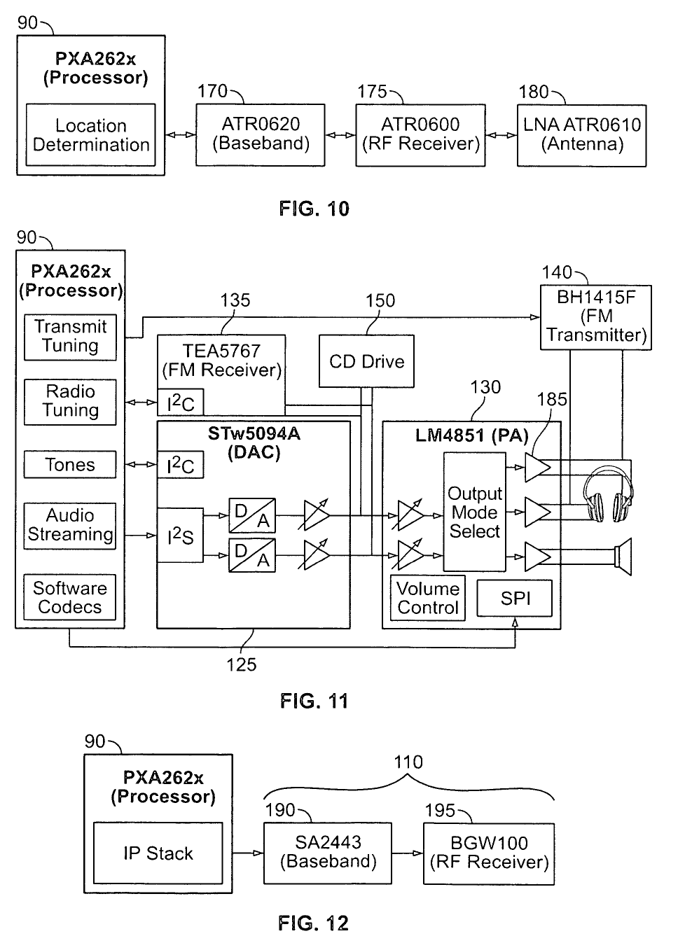

GPS system 115 is based on a chipset such as the Atmel™ chipset. The Atmel™ chipset is a has three components and has a small footprint (400 mm²) and low power consumption parameters (<100 mw @ 1/fix per second). The interface between this chipset and CPU 90 is a UART port 160. As seen in FIG. 10, the components of the GPS system are base band module 170, RF receiver 175 and antenna module 180. Also needed are power control systems to enable CPU 90 to enable or disable GPS subsystem 115 as needed.

Audio Subsystem

Information appliance 10 also incorporates an audio component. The audio subsystem is shown in FIG. 11 and includes CD audio output, FM radio receiver output, digital output from CPU 90, and audio integration with an FM radio transmitter. In more detail these components include CD Drive 150 with serial ATA interface and separate analog audio interface that can connect directly to the power amplifier 130. Also included is FM receiver 135, such as the TES5767 IC from Philips Semiconductor™. This is a small (81 mm²) and low power receiver with simple controls for autonomous tuning. Output from receiver 135 routes directly to the power amplifier 130 interface.

The audio subsystem also includes FM transmitter 140 which may be the BH1414K from Rohm Electronics™. FM transmitter 140 modulates a stereo signal from the audio out signal from power amplifier 130 into a programming RF frequency. A serial interface allows tuning of the transmission frequency by CPU 90.

Power amplifier 130 used in information appliance 10 may be the LM4851 from National Semiconductor™. Power amplifier 130 accepts a single stereo input and provides either a monaural speaker output or a stereo line output signal. The stereo output can be routed to either the FM transmitter 140 for modulation or to stereo output jack 185. In addition to the analogue inputs, a separate digital input is provided to allow CPU 90 to directly provide a waveform to power amplifier 130.

The audio subsystem also includes a digital to audio converter (DAC) 125, such as the STw5094A from ST Microelectronics™. Using the I²C and I²S buses preferably available on CPU 90, integration between CPU 90 and DAC 125 is simple to those with knowledge in the art. Output from DAC 125 is a stereo analogue signal that is routed to power amplifier 130. Audio streaming software on CPU 90 would typically route output to DAC 125 using the I²S bus.

WiFi Subsystem

As seen in FIG. 12, information appliance 10 allows Internet access via a 802.11b wireless interface 110, and may use Philips Semiconductor™ products. A two-piece chipset offers a small footprint (200 mm²) and low power consumption, and includes a SA2443 for the base band 190 and a BGW100 as RF receiver 195. A number of interface options exist, but the UART connection 160 is preferred to communicate with CPU 90.

Software Architecture

Information appliance 10 incorporates a large number of subsystems, which must be linked together and operated using software, such as Linux™ operating system base, although other options are available. Linux™ offers open source technology and is gaining major technical acceptance. A number of Linux™ releases are now available for the limited resources of mobile devices, such as information appliance 10, and software such as Monta Vista Software™ and Linuxworks™ are appropriate for a Linux™ OS in information appliance 10. Both of these Oss offer a base platform derived from the Linux™ OS base 2.6 and are tuned and packaged for a mobile environment. Both OSs will run in as little as 8 MB of memory and within a 16 Mb footprint. Both OS's are also available with board support packages based on the Intel™ PXA2621 processor to support CPU 90. Neither of these software platforms currently include a graphical window manager (which is widely available elsewhere, such as the Monta Vista™ Consumer Electronics Edition of the Linux™ OS coupled with the Graphics for Monta Vista Linux™ windowing environment).

User Interface Paradigm

Preferably the software interface is consistent among the applications and is familiar to the user, such as the common web browser. While this causes some restrictions, the use of XHTML based presentation methodology is adaptable and ubiquitous. Therefore, the services available through information appliance 10 are exposed to the user through a standard web browser interface. In a preferred embodiment, unlike a typical Internet Explorer™ experience, only one instance of the web browser will be available on information appliance 10. As such, there is only one window to view on screen 20 at a time, making a general window manger unnecessary. However, the web browser window should support multiple tabs to manifest new windows within the single window of the software interface.

There are provided two standard sources of input, a QWERTY keyboard 25 and a joystick pointer combination. Like a traditional mouse, the joystick offers controlled cursor movement with two separate click keys.

In addition to these traditional keys, there is preferably a set of eight hard keys 200 positioned above keyboard 25. Hard keys 200 provide immediate access to a tab within the web browser to an associated function. Pressing any of hard keys 200 either initiates a new tab within the browser or brings to the front an already active tab associated with the function selected. Preferably hard keys 200 and their associated functions are as follows:

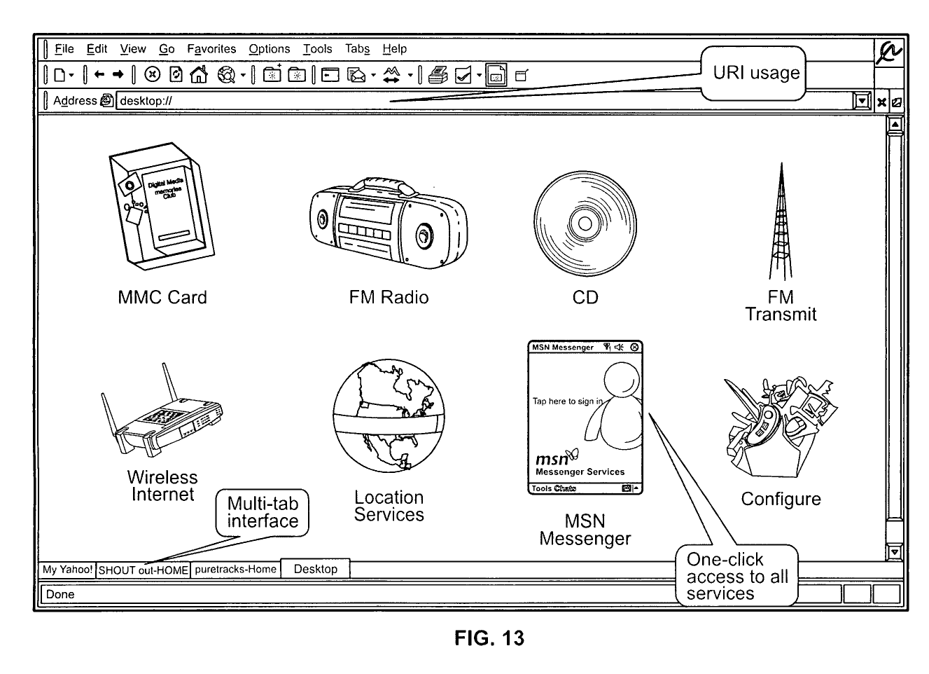

MAIN—Activates the tab containing the main (locally hosted) web page that allows point and click access to all the other built-in functions of information appliance 10 (as seen in FIG. 13).

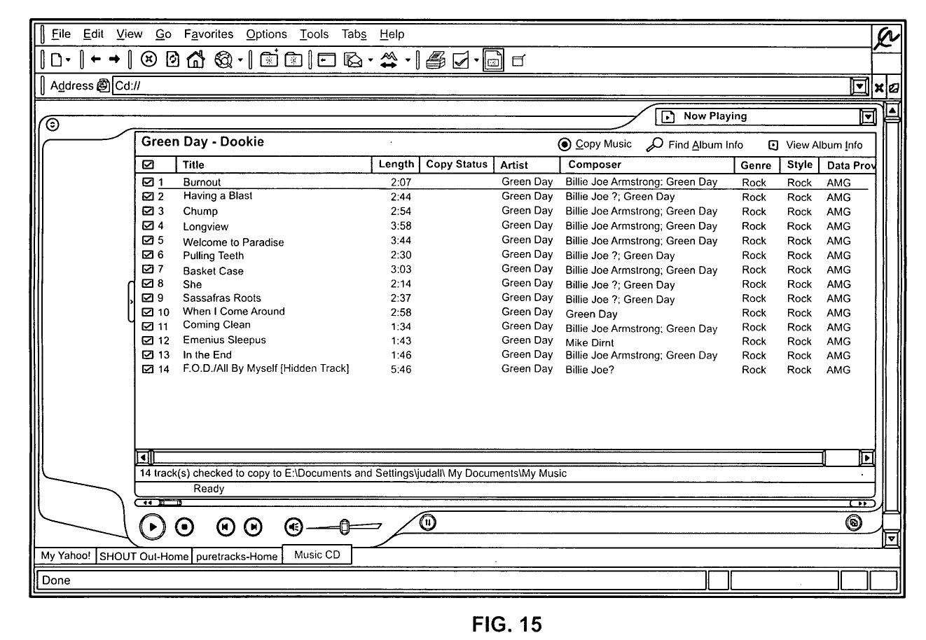

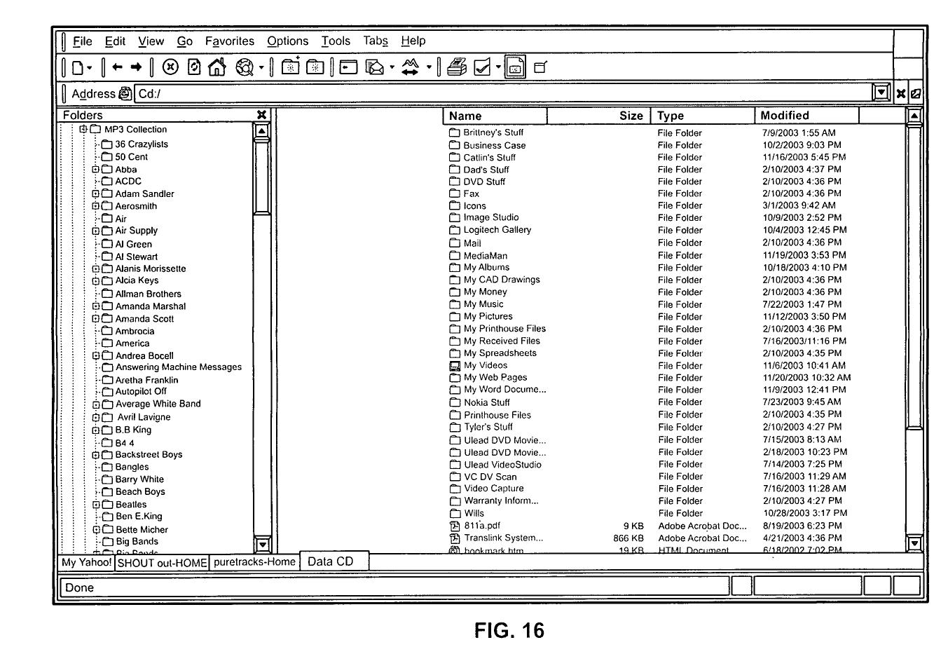

CD—Activates the tab providing the main user interface to CD drive 150. This interface would then permit typical functions associated with a CD player depending on the content of the CD currently installed (as seen in FIGS. 15 and 16).

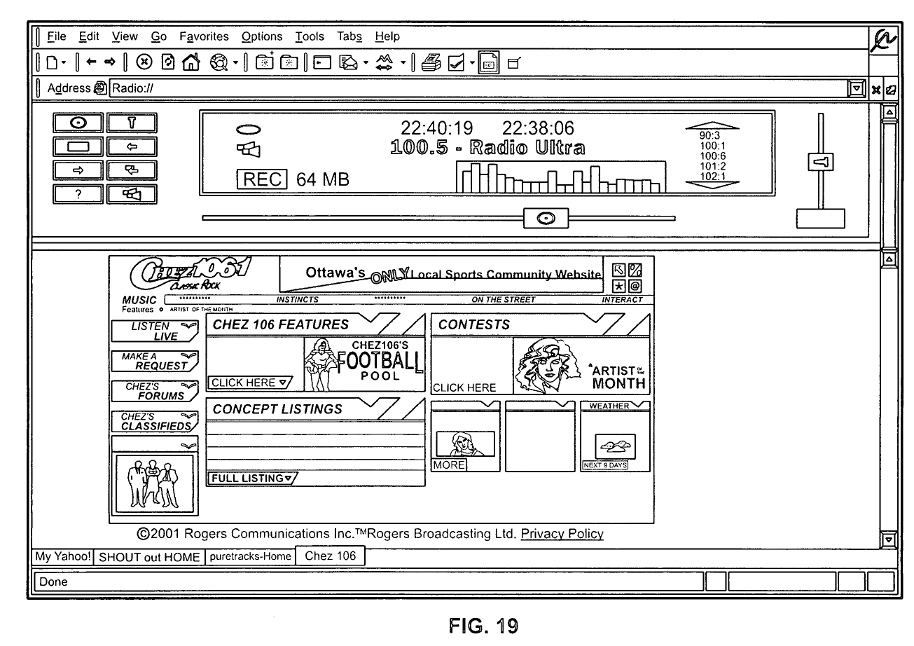

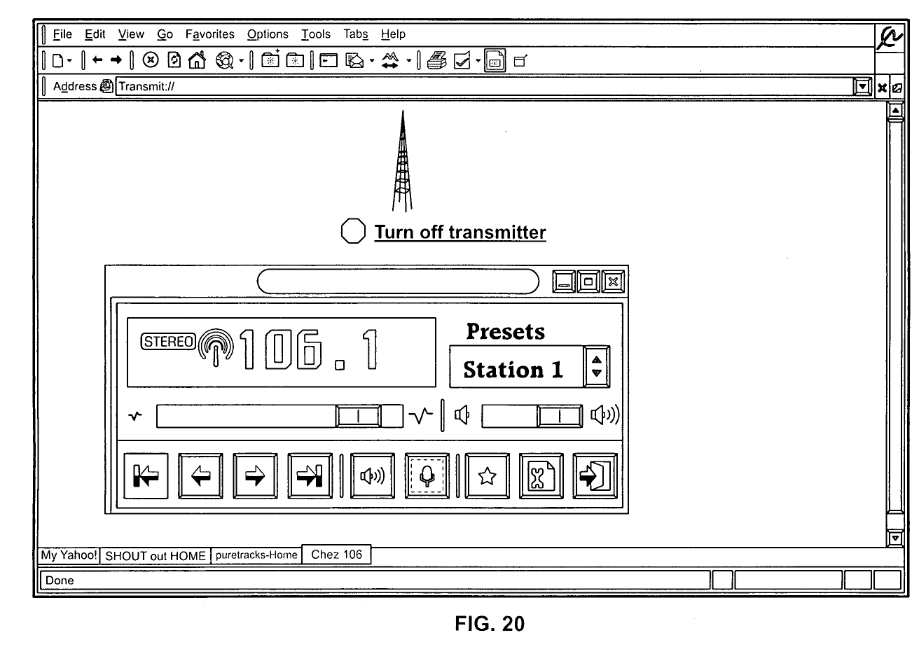

RADIO—Activates the tab that provides the main user interface to both the FM radio receiver and transmitter (as seen in FIGS. 19 and 20).

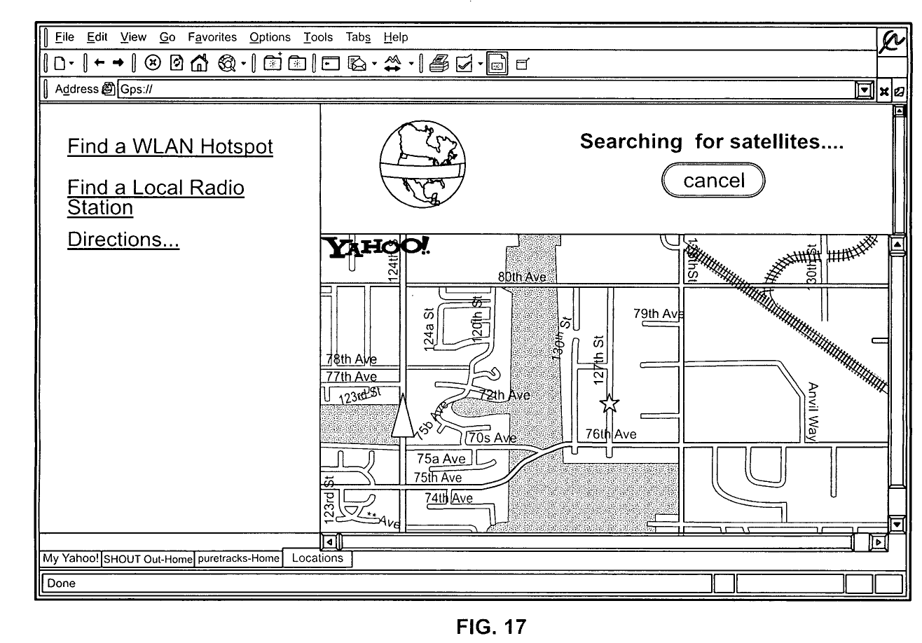

NAVIGATE—Activates the tab that accesses the GPS system to determine the location of information appliance 10 (as seen in FIG. 17).

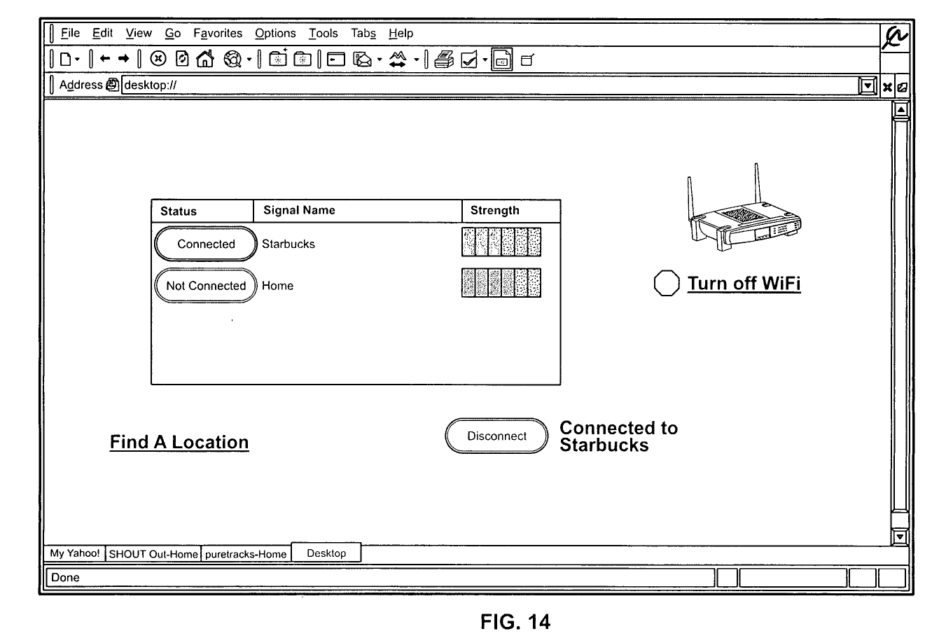

INTERNET—Activates the tab that allows connection of the information appliance 10 to the Internet using a local WiFi service (as seen in FIG. 14).

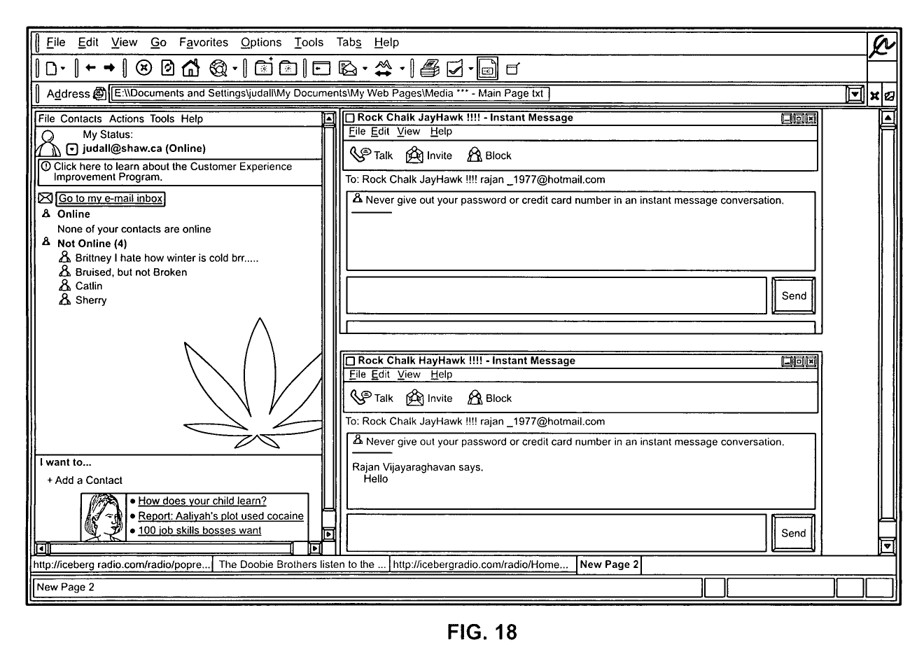

FRIENDS—Activates the tab that enables instant messaging functionality across the MSN Messenger™ or AOL™ messaging networks (as seen in FIG. 18).

STORED DATA—Activates the tab that allows the user to view the contents of the currently installed MMC flash memory card.

TOOLS—Activates the tab that enables the user to configure or otherwise manage information appliance 10 or stored profile information.

In addition to the QWERTY keyboard 25 and the hard keys 200, there are four soft keys 205 located directly under screen 20. The shape of information appliance 10 is such that it can be positioned so that screen 20 may be viewed from the base 210 up, or from edge 215 up. Typically information appliance 10 will be used while viewing screen 20 from the base 215 up, however, when doing certain tasks, such as using the navigation capabilities of the GPS system, it may be preferable to keep information appliance 10 closed but with the screen 20 visible for navigation. In this embodiment of the invention, the keyboard 25 would be covered making input impossible. A touch screen may be used, but provides a disadvantage of having two pointing paradigms, and the necessary support for each. Soft keys 205 allow the use of a simplified interface for an application such as navigation. It is not necessary that all applications support soft keys 205 (or more explicitly the LCD side out mode of operation). For example general web browsing using such a model may be difficult. However certain services such as CD playing, radio tuning, and GPS navigation should support the use of soft keys 205.

When using the soft key mode, the bottom portion of screen 20 is reserved as a mask for the associated keys. In this mode, soft screen keys 205 are displayed at the bottom portion of screen 20 which map to the functions of the unscreened hardkeys 200 directly beneath screen 20 itself.

A number of specific function keys 225 are positioned around the edge of information appliance 10. Function keys 225 primarily control the audio capabilities of information appliance 10 and are similar to the keys provided in a typical portable CD player. Specifically, roller switch 230 controls the audio volume, and function keys 225 are used to play, pause, skip forward and skip backward. Though intended primarily for controlling CD playback, the function keys may be used in other applications of information appliance 10. For example, the skip forward and skip backward function keys while browsing the Internet could be interpreted as the standard page forward or page backward operations. Due to the multi-tasking nature of information appliance 10, there should be a priority mechanism among the different applications in order to use function keys 225 effectively. For example, the user may be simultaneously both listening to a CD as well as web browsing, in which case a priority mechanism should be in place to interpret function keys 225.

Web Browser

As the User Interface is a web browsing environment, this can be accomplished using means known in the art such as the use of a Netscape™ plug-in architecture for web browsing. This architecture permits a web browser to be extended to handle a variety of content types by associating MIME types with dynamically linked libraries. By registering the MIME type with the web browser, an arbitrary dynamically linked library can direct the web browser to direct otherwise unrecognized content to that library for handling. This architecture has the advantage of being able to dynamically add (or remove) functionality to the web browser without supplanting the browser itself.

MIME type registration can be based on either the Uniform Resource Identifier (URI), or the file extension. By adding new URIs, MIME type handlers are created and instantiated within the web browser to access the services provided by information appliance 10. The user also has the option of directly entering a URI for a particular service instead of using hard keys 200. For example, the URI ‘gps:’ may be used to reference the GPS system.

The use of a plug-in architecture is preferably the only way that information appliance is programmable in the conventional sense. Specifically, unlike general-purpose computers, information appliance 10 does not enable the installation of new applications. However, by using the plug-in architecture, new MIME type handlers custom built for operation within the resident browser can be installed. For example, information appliance 10 may not when sold, include the ability to view content in Adobe™ Postscript Display Format (PDF). However, a downloadable plug-in supporting that content type could be written and installed on information appliance 10—thereby enabling information appliance 10 to allow viewing of PDF content.

Plugins will normally be managed by the browser, specifically, dynamically linked libraries that constitute the plugins will be stored in the onboard flash file system of information appliance 10 rather than the external MMC flash file system. As such, though the web browser environment may provide access to manage these plugins, no general file view (as might be present for the external MMC memory) need be available.

The following are suggested new URIs to support the functionality of information appliance 10:

Main:—Access to main screen handler for visual links to all other services;

Gps:—Access to the GPS based navigation service;

Radio:—Access the built-in radio receiver and transmitter; and

Im:—Access the instant messaging service.

Power and State Management

Power management is an important feature of information appliance 10. All peripherals should be capable of acting in either low or no power modes. Using the advanced power management capabilities of an operating system such as Linux™, each device driver should be capable of managing the power requirements of its associated peripheral.

In addition to using power management to conserve energy, it may be important to be able to selectively enable or disable certain peripherals for regulatory reasons. For example to operate information appliance 10 in an aircraft, it may be necessary to disable the WiFi transceiver and the FM transmitter.

File Systems

File systems are stored in the information appliance on three locations: the onboard flash memory, the external user managed MMC memory, and the CD drive. If USB 2.0 is supported, then support for memory via the USB 2.0 interface may also be needed.

The onboard flash memory is used store information appliance 10 services, applications and associated data rather than user content. To optimize this memory space, the cram file system operating under Linux™ is preferably supported. The onboard flash should be formatted to contain a read-only boot cramfs containing boot code and program executables and a second uncompressed read-write Linux™ system for system data storage and data caching.

The external MMC memory should not implement the Linux™ file system. Rather it should operate under the assumption that devices resident in the MMC memory are recognized as FAT (16 or 32). This allows these devices to be either pre-formatted, or formatted within a windows environment and immediately usable in information appliance 10.

In addition to supporting the audio CD format, the CD driver should also support a variety of data file system formats. The CD file systems supported typically are included in the Portable File System (PFS) feature of Linux™. The three data file system formats preferably supported are known as ISO 9660, High Sierra, and Rock Ridge.

In addition to these file systems, CDs should be recognized at the application layer to contain a file type such as generic data, MP3 encoded audio, video CD, or Kodak™ Picture CD. Each of these different types should cause the appropriate interface to be presented to the user.

Internationalization and Localization

The software in information appliance 10 is preferably designed in such a manner as to accommodate different language modules.

MIME Types and Browser Plugins

As previously described, navigation using information appliance 10 is done with a web browser interface. By using the Netscape plug-in architecture extensibility is achieved based on MIME types.

In addition to the custom MIME types that may be required to support some of the peripheral functions of information appliance 10, a number of standard MIME types should also be supported. The following table describes MIME types that are preferably supported by the user interface.

| Mime Type | Description | Suffixes |
|---|---|---|
| application/x- | Macromedia Flash ™ | .swf |
| shockwave-flash | Movie | |
| audio/x-pn- | Real Player ™ | .rpm |
| realaudio-plugin | | |
| application/vnd.rn- | RealOne Player ™ | .rpj |
| realplayer-javascript | Javascript plug-in | |
| image/x-quicktime | QuickTime ™ Image | qtif, qti |
| | File | |
| image/x-sgi | SGI image file | sgi, rgb |
| image/x-targa | TGA image file | targa, tga |
| image/tiff | TIFF image file | tif, tiff |
| image/x-tiff | TIFF image file | tif, tiff |
| video/x-mpeg | MPEG media file | mpeg, mpg, m1s, m1v, |
| | | m1a, m75, m15, mp2, |
| | | mpm, mpv, mpa |
| video/mpeg | MPEG media file | mpeg, mpg, m1s, m1v, |
| | | m1a, m75, m15, mp2, |
| | | mpm, mpv, mpa |
| audio/mpeg | MPEG media file | mpeg, mpg, m1s, m1a, |
| | | mp2, mpm, mpa |
| audio/x-aiff | AIFF audio file | aiff, aif, aifc |
| audio/basic | uLaw/AU audio file | au, snd, ulw |
| audio/mid | MIDI file | mid, midi, smf, kar |
| audio/midi | MIDI file | mid, midi, smf, kar |
| audio/x-midi | MIDI file | mid, midi, smf, kar |
| application/sdp | SDP stream | sdp |
| | descriptor file | |
| application/x-sdp | SDP stream | sdp |
| | descriptor file | |
| application/x-rtsp | RTSP stream | rtsp, rts |
| | descriptor file | |
| video/quicktime | QuickTime ™ Movie | mov, qt |
| video/flc | AutoDesk ™ | flc, fli |
| | Animator (FLC) file | |
| audio/aiff | AIFF audio file | aiff, aif, aifc |
| application/asx | Media Files | * |
| video/x-ms-asf- | Media Files | * |
| plugin | | |
| application/x- | Media Files | * |
| mplayer2 | | |
| video/x-ms-asf | Media Files | asf, asx, * |
| video/x-ms-wm | Media Files | wm, * |
| audio/x-ms-wma | Media Files | wma, * |
| audio/x-ms-wax | Media Files | wax, * |
| video/x-ms-wmv | Media Files | wmv, * |
| video/x-ms-wvx | Media Files | wvx, * |

Java and Java Applets

In a preferred embodiment of information appliance 10 it will also support Java™ Applets and/or Java™ although this is not necessary for information appliance 10 to function.

Performance Requirements

Information appliance 10 should meet a number of performance requirements for regulatory, safety and performance reasons. Ease of use is an important feature of information appliance 10 and therefore a cold boot time should be no more than three seconds. Preferably information appliance 10 supports both cold and warm boots. A cold boot will occur when power is initially provided (such as when batteries are installed). More typically a warm boot will occur.

Under a Linux™ operating environment, the simplest method to affect a warm boot is to support software suspend functionality. As such, the on board flash memory should support a hibernation partition to manage the software suspend. A warm boot operation should typically take less than one second to execute. This performance constraint however will not apply to peripherals as it is neither reasonable nor desirable to always resume power and activity to each peripheral.

The following table describes some of the preferred performance characteristics of information appliance 10.

| Feature | Performance Requirements |
|---|---|
| Power up boot time | <3 seconds |
| Warm boot time | <1 second |
| Battery charge time | <3 hours |
| CD playback time | >6 hours |
| Web browsing | >3 hours |
| Radio listening | >8 hours |
| Radio transmitter | >2 hours |
| GPS navigation active | >3 hours |
| Video playback (streaming) | >2 hours |
| Video playback CD | >2 hours |
| FCC | Part 15 compliant |
| UL | Yes |
| CSA | Yes |

User Interface Specifications

The main visual display on the information appliance 10 is screen 20. Though information appliance 10 preferably supports a rich array of graphic features on screen 20, it is not required to support multiple windows. The multiple-peripherals supported by information appliance 10 run as separate tabs within a single window that occupies the full screen. Multiple windows may appear, but preferably an overlapping window will only appear over the single browser window as the result of a notification popup. Such popups should not occupy the entire screen thus overlapping the browser window and they may be dismissed after a predetermined period of time, or explicitly dismissed by user input.

Each peripheral should allow the instantiation of a new tab within the browser window. In addition, if through the normal course of Internet browsing, a new window is created (such as done with a SHIFT+CLICK operation on a hyperlink), then a new tab is created within the browser window to instantiate that new window. In principle then, there are an unlimited number of tabs, which may exist within a single browser window. Access to these tabs should be provided along the bottom of the browser window with navigation controls to slide these tabs around. That is, though there may be physical limit on the number of visible possible tabs along the bottom of the screen, a scrolling mechanism of sorts (not shown) will allow this number of tabs to be essentially unlimited.

Main Browser Window

The first tab instantiated on power up, and always present once running, is the main browser tab as seen in FIG. 13. This image on this tab permits simple graphic hyperlink access to all peripherals available on information appliance 10. From this tab, clicking on any of the links displayed will either activate or initiate a new tab that brings to the front the associated peripheral or service.

Wireless Browsing

Information appliance 10 should be within the operating vicinity of a WiFi network in order to browse the Internet. Selecting from the main screen, or pressing the INTERNET hard key causes a new tab to be created (or existing tab to be presented) allowing the user to connect to a detected WiFi networks, as seen in FIG. 14.

This tab should list the detected wireless networks and the current state (connected or disconnected) of information appliance 10. It should also allow the user to initiate or terminate a WiFi session and include a hyperlink to locate a WiFi location using the GPS system and a cached database of known WiFi service providers. Clicking on this hyperlink displays a list of WiFi providers and their locations with respect to the current location and an approximate distance to that site.

CD Audio Playback

The CD player tab can be activated by the CD hard key or through the link on the main desktop. The tab should show three main areas, the playlist area, the browsing area and the information area as seen in FIG. 15. This is preferably done within the browser interface model by using multiple frames. If the inserted CD is in fact a data CD and not a recognized media CD, the familiar file management view is presented as seen in FIG. 16.

GPS Navigation

As seen in FIG. 17, the GPS system can be used to determine the location of information appliance 10. Preferably the GPS system can be used to locate local WLAN hotspots or to provide a list of radio stations in the area.

Messaging

Information appliance 10 can also be used for sending MMS messages using conventional means. A view of an embodiment of screen 20 when being used for this purpose is shown in FIG. 18.

Radio Tuning

Information appliance 10 allows users to tune to radio stations within range. A view of an embodiment the radio tuning tab is seen in FIG. 19. As discussed below, the user can view the stations web site while simultaneously listening to the station.

Radio Broadcasting

FIG. 20 is a view of the radio broadcasting screen by which the user transmits the audio over a specified FM frequency. This transmission is very low power in order to comply with FCC radio restrictions. However, in general such transmitted signals should be picked up by any standard FM receiver within a couple of metres of the device.

Forms

To access a number of web sites, information appliance 10 should be able to fill out forms. Therefore information appliance should recognize web pages that solicit standard information requests and allow the user a mechanism to supply the appropriate information automatically. Means for accomplishing this include software from Siber Systems™ called Robo Form™ which permits information to be inserted and text strings to be identified. As a standard XHTML page is parsed, Robo Form™ recognizes forms and prompts the user to automatically fill that data in. Personal information is encrypted and password protected locally on information appliance 10.

Concurrent Radio Tuning and Browsing Navigation

Radio has traditionally relied on only a single medium for transmission, namely the radio spectrum, however, it is now common for radio stations to have associated web sites supplementing their programming. To date, these two media have been divorced from one another, but by correlating a broadcast frequency and the geographic location of the user of the information appliance 10 with a web-site URL, information appliance 10 can direct the user to a specific URL when the radio tuner is tuned to a specific frequency.

By coupling the radio frequency/station with the web URL, radio tuning and web browsing become a single operation. This provides the capability of providing synchronized web streams with radio content which enables a richer end user experience for radio listening.

Based on the radio frequency, location and call name, a database can be maintained to correlate that information with an associated URL. When a radio is tuned to a specific frequency with a geographic range, the web browser is automatically directed to that associated URL. This database can be accessed automatically using the Internet access capabilities of information appliance 10, or it may be stored locally, for example on a CD or flash memory card.

Location Assisted Radio Tuning

Information appliance 10 also allows for location assisted radio tuning. The key requirements for this feature are a GPS system, a database of radio stations associated with geographic locations, and a radio tuner. Therefore, this process can be carried out in a GPS equipped vehicle, for example, and doesn't require all of the features of information appliance 10. Other means of determining the location of the radio tuner could be used as an alternative to the GPS system.

Free broadcast radio stations have a limited coverage range. Once outside a familiar range (e.g. a user's home location), the availability and nature of the local stations is typically unknown. Finding radio stations is usually achieved under these circumstances by scanning and sampling the available frequencies for a station that appeals to the user. Information appliance 10 can use location determination technology in conjunction with a database to provide the user with a list of available stations and their frequencies. Associated database information may also include the radio station genre to aid the listener in selecting a station.

This allows the user, upon entering a new geographic area, to determine what radio stations are available for listening or to locate the local broadcast frequency of a national radio network instead of scanning and sampling the stations.

By correlating the user's geographic position with the available radio frequencies, a comprehensive and accurate list of available broadcast can be easily presented to the listener, making the process of station tuning to a particular network simple and quick. One manner of implementing this feature is by coordinating the GPS system with a database. The database would minimally contain the radio station frequency and the associated geographic range information, and may have other information about the station such as genre. Based on the current geographic location as determined by the GPS, that database is filtered to present only the available signals for a particular area.

The database could be accessible via the Internet using information appliance 10's WLAN capability, or it could be available on a storage medium, such as a CD or a flash memory card.

Location Assisted WLAN Finder

Another feature of information appliance 10 is that it allows the user to determine the location of WLAN access points by using the GPS system and a database with information about WLAN access points within a particular location.

WLAN technology enables wireless connectivity to the Internet but the coverage area of WLAN networks is limited. Public WLAN access points are known as “hotspots” and offer this service in limited geographic area. It is difficult for a user to know the location of hotspots, particularly if they are unfamiliar with the area in question. By coordinating a database of such hotspots with location determination technology, it is possible, based on the current geographic location of information appliance 10, to find the nearest available WLAN hotspot.

Upon arrival in a geographic area, a user would typically either visually look or otherwise obtain knowledge of WLAN hotspots. Alternately, the mobile user may enable a WLAN transceiver and wander about looking for WLAN radio signals. Both methods are tedious and far from complete. By correlating the geographic position with the known WLAN locations, information appliance 10 can now find the nearest (or indeed any) WLAN hotspot, eliminating the manual method of discovering such.

Information appliance 10 should support a database of WLAN access points and their associated geographic locations. Then based on the current location of the device (as determined by GPS system, information appliance 10 can query the database to find a list of hotspots sorted in order of proximity to the user.

Although the particular preferred embodiments of the invention have been disclosed in detail for illustrative purposes, it will be recognized that variations or modifications of the disclosed apparatus lie within the scope of the present invention.

The invention claimed is:

1. An information appliance, comprising:
(a) means for reading a pre-recorded media;
(b) a keyboard;
(c) a screen;
(d) means for WLAN connectivity;
(e) a GPS receiver; and
(f) a speakers and a amplifier.

2. A method of experiencing media, comprising:
(a) selecting a radio frequency using an information appliance;
(b) accessing a record to determine an association with said radio frequency and a web page; and
(c) displaying said associated web page on said information appliance.

3. A method of selecting a radio frequency, by a listener, on an information appliance comprising a GPS receiver, said method comprising:
(a) determining, using the GPS receiver, the location of said listener
(b) accessing a database to determine a plurality of radio stations available at said location; and
(c) presenting, for selection by said listener, on said information appliance, at least one of said available radio stations.

4. A method of locating a WLAN access point, by a user using an information appliance comprising a GPS receiver, comprising:
(a) determining, using a GPS receiver, the location of said listener
(b) accessing a database to determine a plurality of WLAN access points available at said location; and
(c) presenting, for selection by said user, at least one of said WLAN access points.
